(19) United States
(12) Patent Application Publication
(10) Pub. No.: US 2013/0044986 A1
(43) Pub. Date: Feb. 21, 2013

(54) SINGLE-MODE TO MULTI-MODE OPTICAL FIBER CORE MATCHING AND CONNECTORIZATION USING A TAPERED FIBER

(71) Applicants: David Zhi Chen, Richardson, TX (US); Mark Anthony Ali, Cockeysville, MD (US)

(72) Inventors: David Zhi Chen, Richardson, TX (US); Mark Anthony Ali, Cockeysville, MD (US)

(73) Assignee: VERIZON PATENT AND LICENSING INC., Basking Ridge, NJ (US)

(21) Appl. No.: 13/211,519

(22) Filed: Aug. 17, 2011

(51) Int. Cl. G02B 6/255; B23P 11/00

(52) U.S. Cl. 385/96; 385/95; 29/428

(57) ABSTRACT

An apparatus comprises a first fiber segment having a core that transitions from a first core diameter at a first end to a second core diameter at a second end. The first core diameter is smaller than the second core diameter, and the second end is attached to a connector. The apparatus may further include a second fiber segment having a core with the first diameter, wherein the first end of the first fiber segment is spliced onto the second fiber segment. In one embodiment, the small diameter ends of two tapered fiber segments are core-aligned and fusion spliced to the ends of a length of a single-mode fiber and the large diameter ends of the two tapered fiber segments are attached to a connector.

### BACKGROUND INFORMATION

Fiber optic cables often deliver services and content (e.g., movies, television programs, internet, telephone, etc.) to subscriber houses, condos, apartments, and office buildings. The optical fibers in those cables may include single-mode fibers or multi-mode fibers. A multi-mode fiber typically includes a core that is approximately 50 μm in diameter with an outer cladding that brings the total fiber diameter to approximately 125 μm. A single-mode fiber typically includes a core that is approximately 9 μm in diameter with an outer cladding that brings the total fiber diameter to approximately 125 μm.

### BRIEF DESCRIPTION OF THE DRAWINGS

FIGS. 1A and 1B illustrate exemplary connections between optical fibers;

FIG. 1C illustrates an exemplary network in which embodiments described herein may be implemented;

FIG. 1D illustrates a portion of the optical network of FIG. 1C;

FIG. 2 is a diagram of a portion of the exemplary multiple dwelling unit of FIG. 1D;

FIG. 3 is a simplified diagram illustrating exemplary optical fibers that run from the central office of FIG. 1C to the optical network terminal of FIG. 2;

FIG. 4 illustrates an exemplary optical splitter;

FIG. 5A illustrates the face of an exemplary single-mode fiber;

FIG. 5B illustrates the face of an exemplary multi-mode fiber;

FIG. 5C illustrates an exemplary tapered fiber in one embodiment;

FIG. 5D illustrates the tapered fiber of FIG. 5C core-aligned and spliced to a single-mode fiber;

FIG. 5E illustrates tapered fiber core-aligned and spliced to the other end of the single-mode fiber of FIG. 5D;

FIG. 6A illustrates an exemplary fiber optic cable that includes two tapered fibers at each end of a single-mode fiber with two connectors on each end of the cable;

FIG. 6B illustrates an exemplary fiber optic cable that includes a tapered fiber at one end of a single-mode fiber with a connector on the other end for receiving the cable of FIG. 6A;

FIG. 7A illustrates an exemplary machine to manufacture a tapered optical fiber in one embodiment;

FIGS. 7B and 7C illustrate another exemplary machine to manufacture a tapered optical fiber in another embodiment;

FIGS. 8A and 8B illustrate an exemplary optical network in which embodiments described herein may be implemented;

FIGS. 9A and 9B illustrate an exemplary fiber array connector and an exemplary ribbon connector in different embodiments;

FIG. 9C illustrates a cross section of a portion of connectors of FIGS. 9A and 9B;

FIG. 10 is a flowchart of an exemplary process for manufacturing cables according to the embodiments described herein; and

FIG. 11 is a flowchart of an exemplary process for using fiber optic cables according to the embodiments described herein.

### DETAILED DESCRIPTION OF PREFERRED EMBODIMENTS

The following detailed description refers to the accompanying drawings. The same reference numbers in different drawings may identify the same or similar elements.

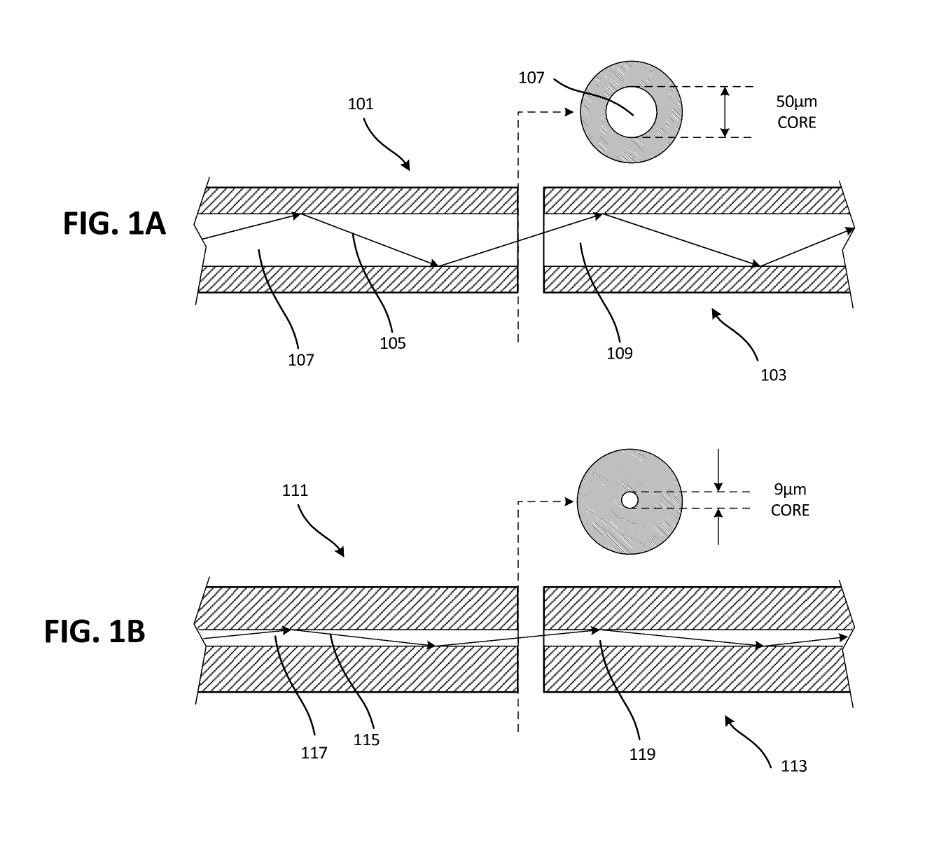

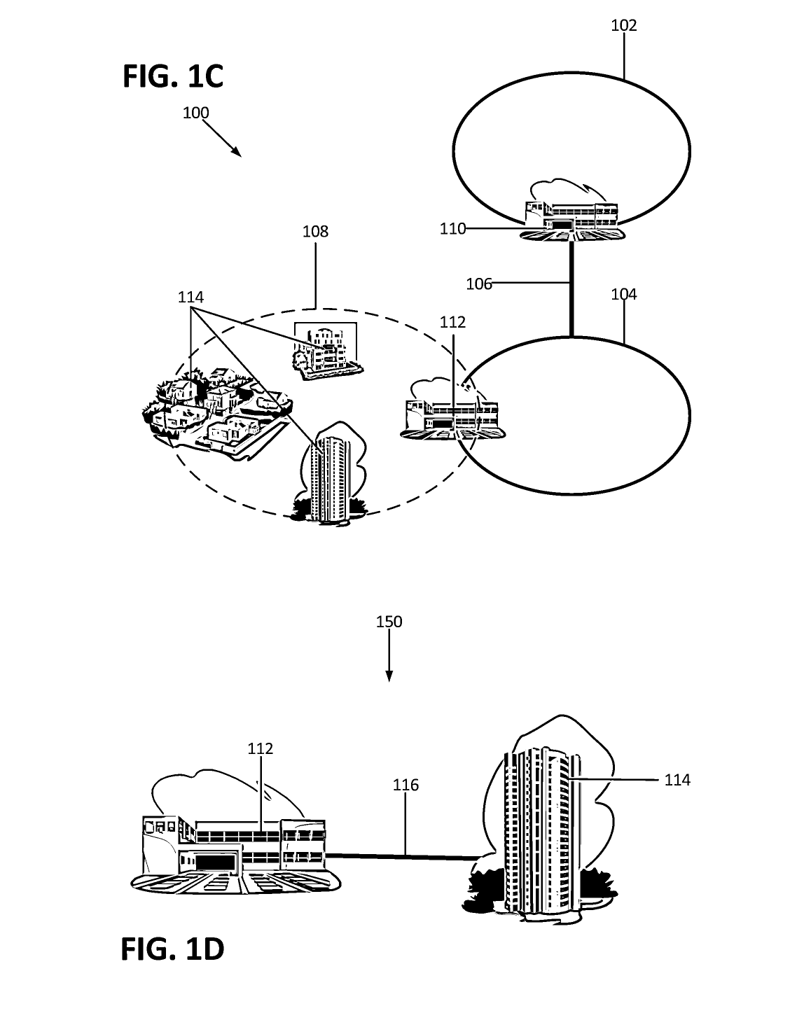

FIG. 1A illustrates a connection between an optical fiber 101 and an optical fiber 103. As shown, the end face of fiber 101 is placed in close proximity to the end face fiber 103. In this case, light 105 passes through a core 107 of fiber 101 into a core 109 of fiber 103. In this example, core 107 is approximately 50 μm in diameter. If the face of fiber 101 or fiber 107 is dirty, for example, then light 105 may be obstructed (e.g., in part) and may not pass from fiber 101 to fiber 103 with the intensity it would otherwise. Further, if fiber 101 and fiber 107 are not properly aligned, then light 105 passing from fiber 101 to fiber 103 may also be obstructed (e.g., in part) and may not pass from fiber 101 to fiber 103 with the intensity it would otherwise.

FIG. 1B illustrates a connection between an optical fiber 111 and an optical fiber 113. As shown, the end face of fiber 111 is placed in close proximity to the end face of fiber 113. In this case, light 115 passes through a core 117 of fiber 111 into a core 119 of fiber 113. In this example, core 117 is approximately 9 μm in diameter. As with FIG. 1A, if the face of fiber 111 or fiber 113 is dirty, then light 115 may be obstructed (e.g., in part) and may not pass from fiber 111 to fiber 113. Likewise, if fiber 111 or fiber 113 is not properly aligned, then light 115 passing from fiber 111 to fiber 113 may also be obstructed (e.g., in part).

Aligning fibers 111 and 113 (see FIG. 1B) is generally more difficult than aligning fibers 101 and 103 (see FIG. 1A) because the core diameters of fibers 111 and 113 are smaller than the core diameters of fibers 101 and 103. Further, keeping the core surface of fibers 111 and 113 clean (see FIG. 1B) is generally more difficult than keeping the core surface of fibers 101 and 103 (see FIG. 1A) clean, also because of the difference of the core diameters. Therefore, a technician has to spend more time, skill, and effort to connect the fibers of FIG. 1B than the fibers of FIG. 1A. Despite this disadvantage, small cores provide benefits for the transmission of data, particularly over long distances.

Embodiments disclosed herein allow for the connection of fibers with small cores by introducing tapered sections at the end of the fibers. The tapered sections increase the size of the cores at the end of the fibers. Therefore, in one embodiment, the connections between the fibers have the benefits of the connections of large-core fibers. Because the tapered sections may be relatively short, however, the disadvantages of larger-core fibers may not be significant and/or may be minimized.

FIG. 1C shows an exemplary optical network 100 in which the embodiments described herein may be implemented. As shown, optical network 100 may include metro/regional networks 102 and 104, long haul or ultra-long haul optical lines 106, and edge network 108. Depending on the implementation, optical network 100 may include additional, fewer, or different optical networks and optical lines than those illustrated in FIG. 1C. For example, in one implementation, optical network 100 may include additional edge networks and/or metro/regional networks that are interconnected by Synchronous Optical Network (SONET) rings.

Metro/regional network 102 may include optical fibers and central office hubs that are interconnected by the optical fibers. The optical fibers, which may form the backbone of metro/regional network 102, may span approximately 50 to 500 kilometers (km). The central office hubs (also called “central office”), one of which is illustrated as central office hub 110, may include sites that house telecommunication equipment, including switches, optical line terminals, etc. In addition to being connected to other central offices, central office hub 110 may provide telecommunication services to subscribers, such as telephone service, access to the Internet, cable television programs, etc., via optical line terminals.

Metro/regional network 104 may include similar components as metro/regional network 102. Network 104 may operate similarly as network 102. In FIG. 1C, metro/regional network 104 is illustrated as including central office 112, which may include similar components as central office hub 110. Central office 112 may operate similarly as central office hub 110. Centro office 112 may be a clean environment, for example, where highly trained technicians are adept at properly connecting fibers, even single-mode fibers described in FIG. 1B.

Long haul optical lines 106 may include optical fibers that extend from metro/regional optical network 102 to metro/regional network 104. In some implementations, long haul optical lines 106 may span approximately 500 km or more.

Edge network 108 may include optical networks that provide user access to metro/regional network 104. As shown in FIG. 1C, edge network 108 may include access points 114 (e.g., office buildings, residential area, etc.) via which customers may obtain communication services from central office 112.

In network 100, each of networks 102, 104, and 108 is exemplary. Accordingly, depending on the implementation, each of networks 102, 104, and 108 may include additional, fewer, or different networks, hubs, and/or access points than those illustrated in FIG. 1C. For example, edge network 108 may include additional access points, central office hubs, etc.

FIG. 1D shows a portion 150 of optical network 100. As shown in FIGS. 1C and 1D, portion 150 may be part of edge network 108, and may include central office 112, access point 114, and feeder optical fiber cable 116. Depending on the implementation, portion 150 may include additional, fewer, or different components than those illustrated in FIG. 1D, such as, for example, facilities for housing amplifiers.

Access point 114 may include a multiple dwelling unit or single dwelling unit. A multiple dwelling unit may include, for example, apartments, offices, condominiums, and/or other types of occupancy units that are vertically aggregated in a high-rise or another type of building. A single dwelling unit may include attached town houses, single detached houses, condominiums, and/or other types of horizontally aggregated occupancy units. In the following description, for simplicity, access point 114 is described in terms of a multiple dwelling unit 114.

Feeder optical fiber cable 116 may include optical fiber cable bundles that interconnect a multiple dwelling unit complex and/or a single dwelling unit complex to optical line terminals (OLTs) in central office 112.

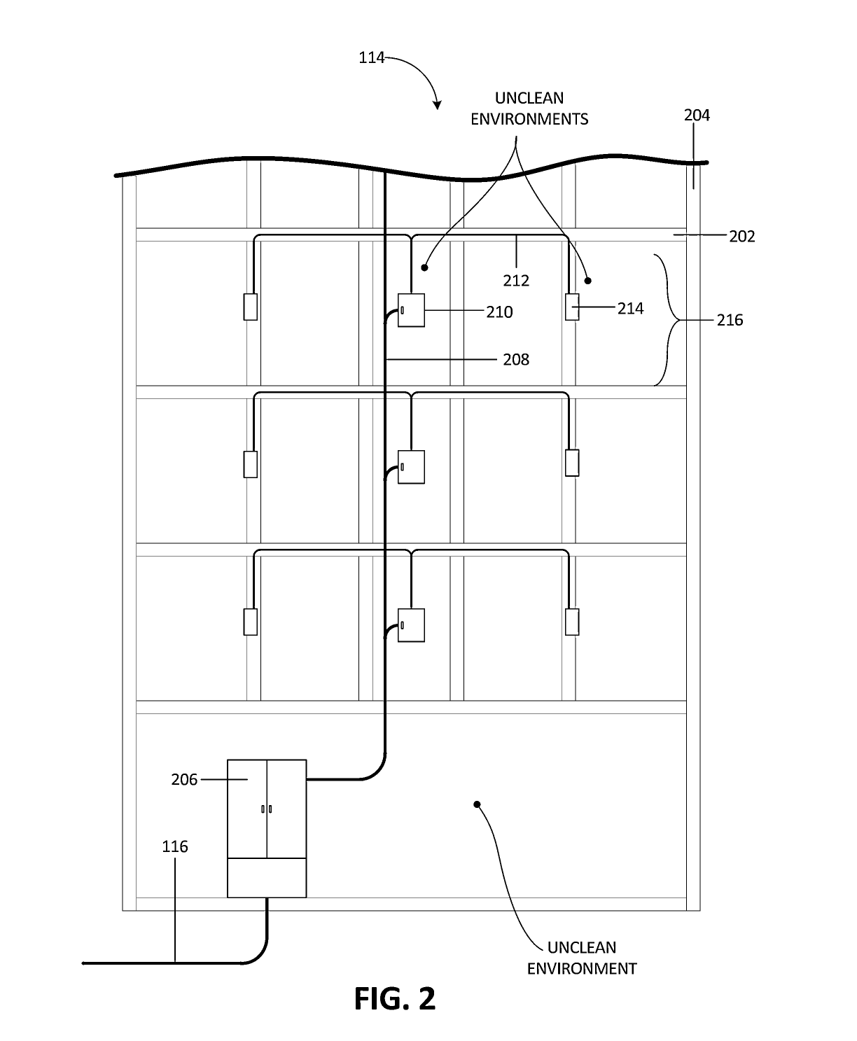

FIG. 2 is a diagram of a portion of multiple dwelling unit 114. As shown, multiple dwelling unit 114 may include a floor/ceiling 202, a wall 204, a fiber distribution hub (hub) 206, distribution cables 208, a fiber distribution terminal 210, a drop cable 212, an optical network terminal (ONT) 214, and an occupancy unit 216. In FIG. 2, some components of the multiple dwelling unit 114 are omitted for the sake of simplicity (e.g., stairs, doors, elevators, etc.). In addition, depending on the implementation, multiple dwelling unit 114 may include additional, fewer, or different components than those illustrated in FIG. 2. For example, in some implementations, fiber distribution terminal 210 may be connected to hub 206 through another component, such as a collector box that receives ribbon cables, and provides the ribbon cables connectivity to fiber distribution terminals.

Ceiling/floor 202 and wall 204 may partition space within multiple dwelling unit 114 into multiple occupancy units. Hub 206 may include an enclosure (e.g., a plastic or metal cabinet) to receive feeder optical fiber cable 116, split an optical signal on an optical fiber within optical fiber cable 116 into multiple optical signals, convey the split optical signals to fiber distribution cables, collect the fiber distribution cables into distribution cables 208, and provide distribution cables 208 to fiber distribution terminals 210 or to ONTs 214.

Distribution cables 208 may include riser cables that carry optical fibers from hub 206 to fiber distribution terminal 210. In some implementations, distribution cables 208 may be tapered as it is routed vertically through multiple dwelling unit 114 and as fiber distribution cables are branched from distribution cables 208 to feed into one or more of fiber distribution terminal 210. Fiber distribution terminal 210 may include an enclosure to receive a fiber distribution cable from distribution cables 208.

Drop cable 212 may include an optical fiber that carries an optical signal from a fiber distribution cable in fiber distribution terminal 210 to ONT 214. Typically, drop cable 212 may be installed in a raceway that is placed along the ceiling of a hallway, in a conduit, in a duct, etc.

ONT 214 may receive optical signals via drop cable 212 and convert the received optical signals into electrical signals that are further processed or carried over, for example, copper wires to one or more occupancy units. In some implementations, ONT 214 may be placed within an occupancy unit, and devices that use services offered by central office 112 may be directly connected to ONT 214.

Occupancy unit 216 may include a partitioned space that a tenant or an owner of the occupancy unit 216 may occupy. Occupancy unit 216 may house devices that are attached directly or indirectly, via copper wires, to ONT 214 to receive services that central office 112 provides.

In some instances, however, the basement (e.g., where hub 206 may be located) and the closet (e.g., where ONT 214 and distribution terminal 210 may be located) may be unclean environments. Such unclean environments pose a challenge when connecting a fiber optic cable to devices. In such unclean environments, the face (e.g., the core) of a fiber is more likely to become dirty and limit the intensity of light that passes from one cable to the next. Further, in such environments, the technicians may not have the technical skill and knowhow to properly connect cables, particularly cables that expose single-mode cores in their connectors.

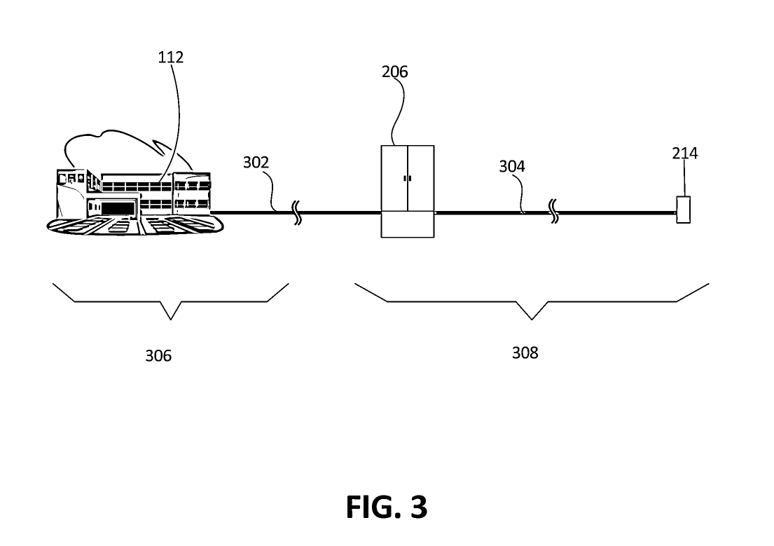

FIG. 3 is a simplified diagram illustrating the optical fibers that run from central office 112 to ONT 214. FIG. 3 shows one or more of single-mode optical fiber cable 302, which may be bundled within feeder optical fiber cable 116 (see FIG. 1D), that run from an optical line terminal in central office 112 to hub 206. One end of single-mode optical fiber cable 302 may be housed in a clean environment 306 with highly skilled technicians, for example. FIG. 3 also shows fibers 304 (which may be encased with distribution cables 208 and/or drop cable 212 (see FIG. 2)) that run from hub 206 to ONT 214. One end of single-mode optical fiber cable 302 and both ends of fibers 304 may be housed in an unclean environment (at least not as clean as central office 112), for example. Further, the skilled technicians, while present in central office 112, may not be present in dwelling unit 114.

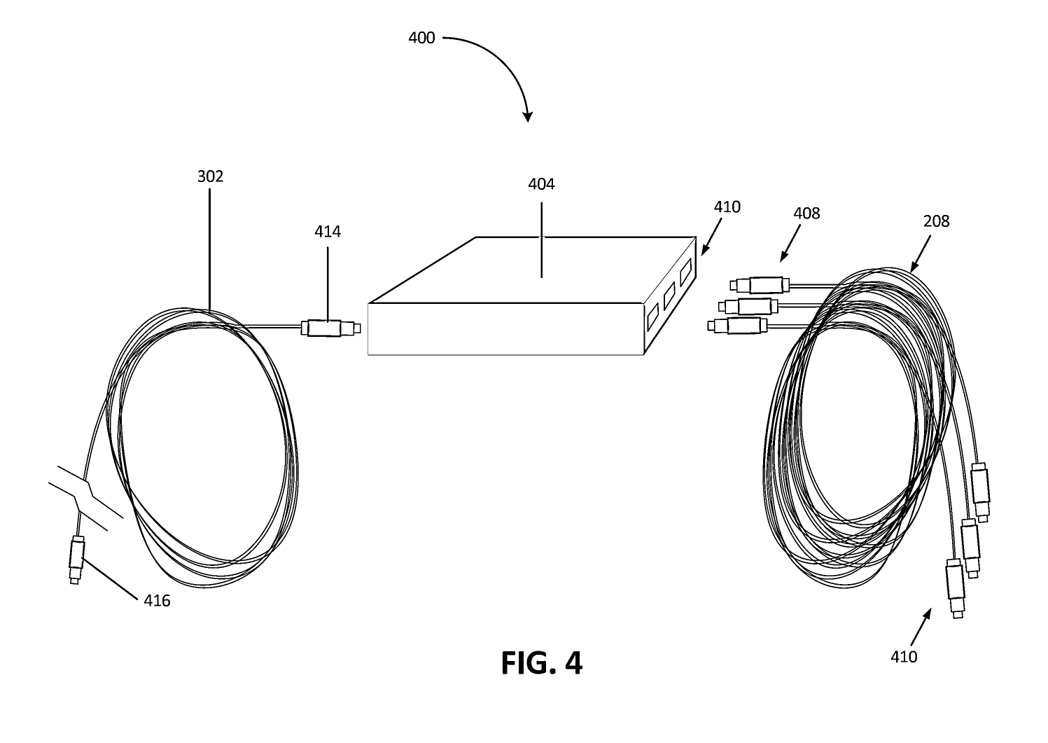

In hub 206, single-mode fiber cable 302 is coupled to fibers 304 via an optical splitter. FIG. 4 shows an exemplary optical splitter 400. As shown, optical splitter 400 may include input cable 302, housing 404, and output cables 208. Depending on the implementation, optical splitter 400 may include additional, fewer, different, or different arrangement of components than those illustrated in FIG. 4.

Output cables 208 may include connectors 408 that fit into corresponding sockets 410. Input cable 302 may include a connector 414 that fits into a corresponding socket (not shown). Input cable 302 may also include a connector 416 that connects to equipment (not shown) in central office 112.

Housing 404 may encase the optical splitter module. The optical splitter module may receive an input optical signal from input cable 302, split the signal into a number of optical signals, and provide the split signals to output cables 208. Output cables 208 may convey the split signals from the optical splitter module within housing 404 to fiber distribution terminal 210.

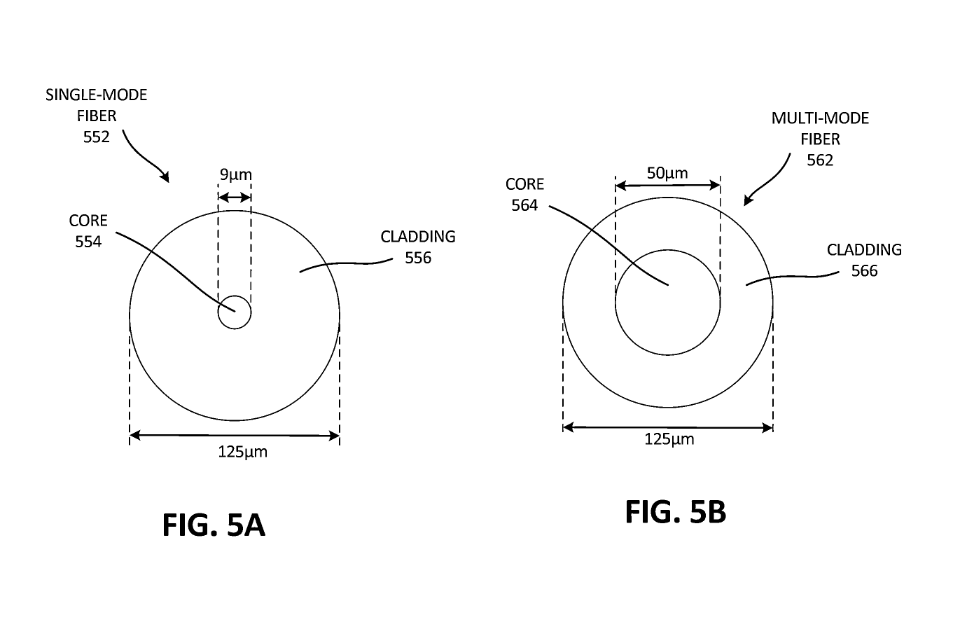

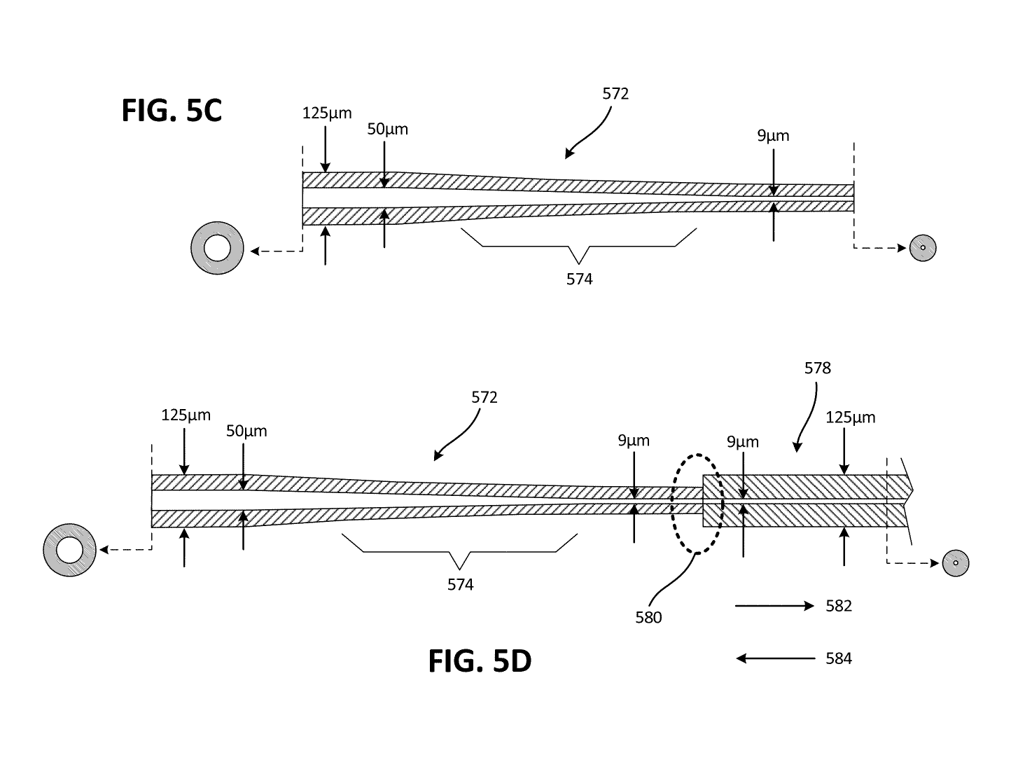

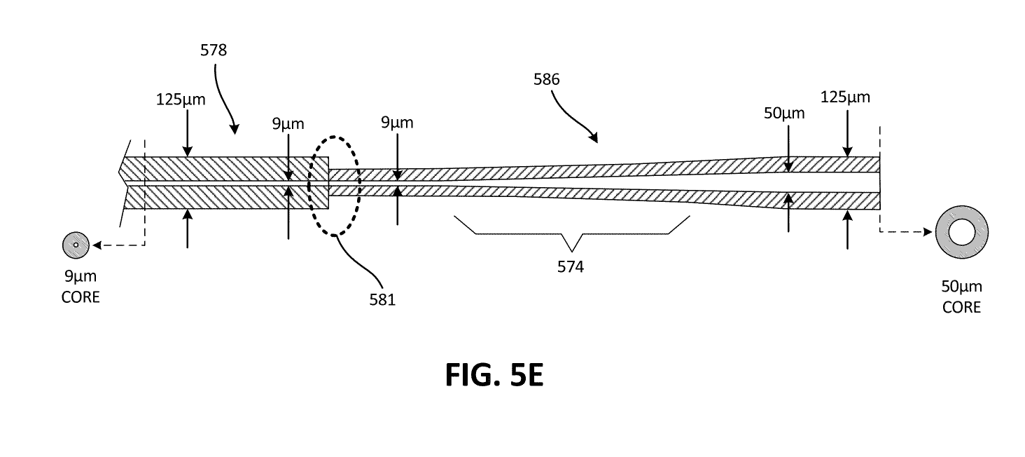

As discussed above, input cable 302 (e.g., as part of bundle 116) may include a single-mode optical fiber. FIG. 5A is a diagram of the face an exemplary single-mode fiber 552. A single-mode optical fiber is an optical fiber designed to carry only a single ray of light (mode). As shown in FIG. 5A, fiber 552 includes a core 554 that has a diameter that is between 8 and 10 μm. Fiber 552 also includes a cladding 556 with a diameter that brings the total diameter of the fiber to 125 μm. Typically, a highly trained technician would connect cable 302 (e.g., using connector 416) to the equipment (not shown) in central office 112, for example. The highly-trained technician is typically employed by the company that provides the communication services to building 114, for example. The highly-trained technician may ensure that the face of single-mode fiber 302 is sufficiently clean, polished, and/or aligned so as not to degrade the signal traveling into or out of fiber 302.

While the process of ensuring that the connection face of the single-mode fiber cable 302 is sufficiently clean is within the skill set of the highly-trained technician, the highly-trained technician may not be present in dwelling unit 114. In many instances a subcontractor or a building engineer may be responsible for connecting cables (e.g., cable 302 or cables 208) to optical splitter 400. The building engineer and the subcontractor may not have the same level of training as a technician in central office 112. Further, the cables and equipment in dwelling 114 may be in a more dirty (e.g., unclean) environment than the cables and equipment in central office 112, for example. In this case, it may be challenging for the building engineer or subcontractor to connect single-mode fiber cables to equipment without signal degradation, for example.

In contrast to the face of a single-mode fiber, FIG. 5B is a diagram of the face of an exemplary multi-mode fiber 562. Multi-mode optical fibers are usually used for communication over short distances (e.g., less than 600 m). As shown in FIG. 5B, fiber 562 includes a core 564 that has a diameter that is 50 μm. Fiber 562 also includes a cladding 566 with a diameter that brings the total diameter of the fiber to 125 μm. It is generally easier to clean, polish, and/or align the face of a multi-mode fiber with the face of another multi-mode fiber, for example, because the diameters of the cores are larger. As discussed in more detail below, the benefits of a connection between multi-mode fiber may be realized with a single-mode fiber through the use of tapered fiber segments.

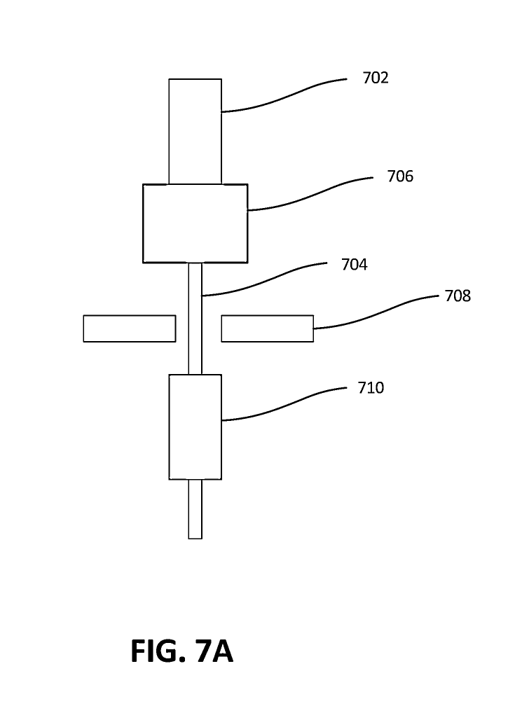

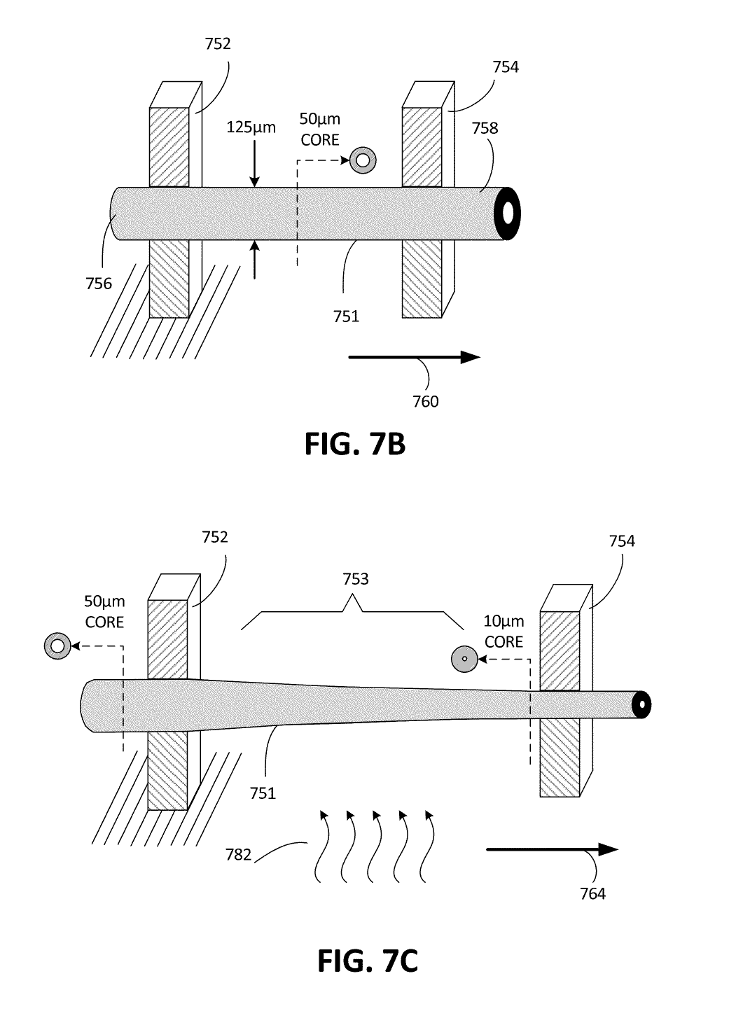

FIG. 5C is a diagram of an exemplary tapered fiber 572. The manufacture of tapered fiber 572 is described in more detail below with respect to FIGS. 7A, 7B, and 7C. Tapered fiber 572 has one end that includes a core diameter of 50 μm, for example. The other end includes a core diameter of 9 μm. In between the two ends is a tapered portion 574 that transitions between a 50 μm core and a 9 μm core. In one embodiment, the transition of the core is linear. Other transition functions are possible. Core diameters other than those shown in FIG. 5C are possible. For example, one end of tapered fiber 572 may be 62.5 μm rather than 50 μm. As another example, the other end of tapered fiber 572 may be 8 μm or 10 μm rather than 9 μm. In one embodiment, tapered fiber 572 may be coated with additional cladding so as to keep the outer diameter of tapered fiber 572 constant (e.g., 125 μm) even though the core diameter may change from 50 μm to 9 μm. Tapered fiber 572 may vary in length from a centimeter to many meters. For example, tapered fiber 572 may be 1 cm, 2 cm, 4 cm, 6 cm, 10 cm, 15 cm, 20 cm, 50 cm, 100 cm, 1 m, 2 m, 4 m, etc., in length. In one embodiment, tapered fiber 572 may be less than 1 cm or between any length listed above, for example. Tapered fiber 572 may also be longer than 4 m. The longer the length, the greater the negative effects of the problems associated with multi-mode fibers, however.

FIG. 5D is a diagram of exemplary tapered fiber 572 coupled (e.g., core-aligned and fusion spliced) to a single-mode fiber 578 at junction 580. As shown, the end of tapered fiber 572 having a 9 μm diameter core is core-aligned and fusion spliced to an end of single-mode fiber 578 that also has a 9 μm diameter core. In one embodiment, tapered fiber 572 is core-aligned and fusion spliced to single-mode fiber 578 at junction 580. Fusion splicing uses heat to join together two optical fibers, e.g., small core diameter section of tapered fiber 572 and single-mode fiber 578 at junction 580. In this embodiment, light traveling in the direction of arrow 582 from tapered fiber 572 will be guided from a larger diameter core (e.g., 50 μm) to a smaller diameter core (9 μm). Light traveling in the direction of arrow 584 from fiber 578 to fiber 572 will be guided from a smaller diameter core (e.g., 9 μm) to a larger diameter core (e.g., 50 μm). Thus, in this embodiment, the resulting fiber (after tapered fiber 572 and fiber 578 are core-aligned and fusion spliced together) is a single-mode fiber having a multi-mode face (e.g., with a 50 μm core).

In one embodiment, the other end of fiber 578 may also be coupled (e.g., core-aligned and fusion spliced) to a tapered fiber. FIG. 5E is a diagram of the other end of fiber 578 coupled to another tapered fiber 586. As shown, the end of tapered fiber 586 that has a 9 μm diameter core is core-aligned and fusion spliced to the other end of single-mode fiber 578 that also has a 9 μm diameter core. Tapered fiber 572 may be core-aligned and fusion spliced to single-mode fiber 578 at junction 581.

As mentioned above, tapered fibers (e.g., tapered fibers 586 and 572) may be relatively short (e.g., a few centimeters or shorter). Fiber 578 may be very long (e.g., many kilometers). Thus, after splicing tapered fibers 572 and 586 to fiber 578, the resulting fiber may have the benefits of a single-mode fiber with a smaller core (e.g., 10 μm) while also having the benefits of a larger core at the ends (e.g., 50 μm) (e.g., for connection purposes).

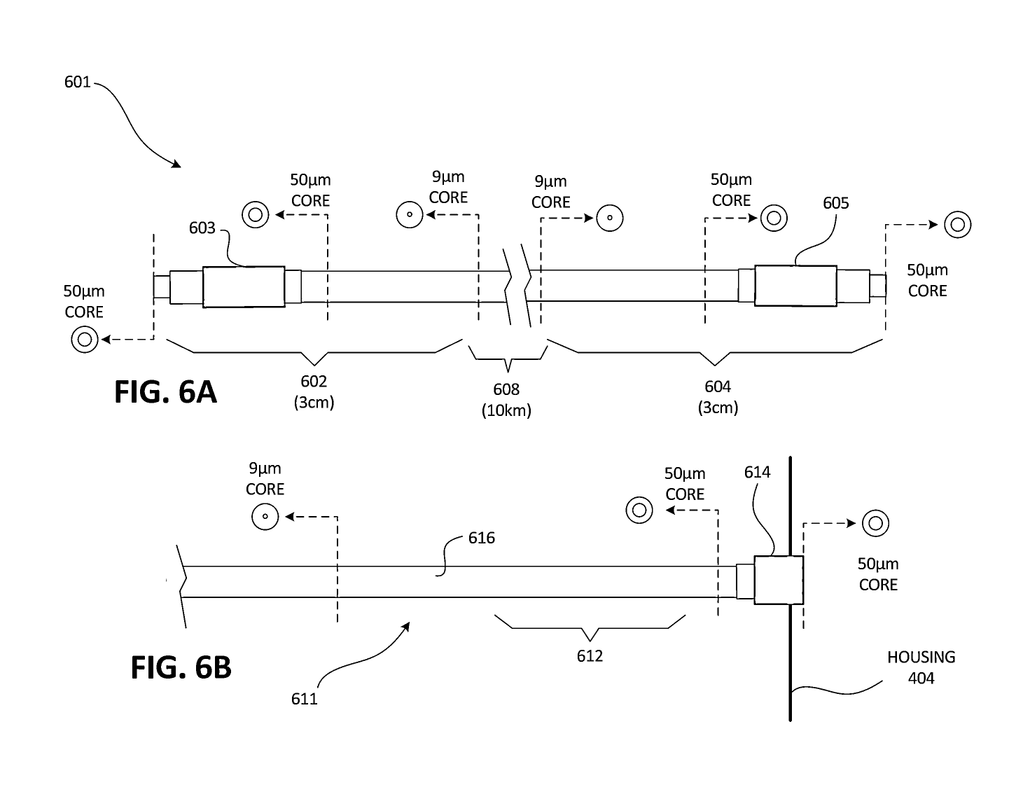

The resulting fiber (formed by tapered fibers 572 and 586 and fiber 578) may also include an additional protective coating or jacket and a connector body. FIG. 6A is a diagram illustrating a fiber optic cable 601 according to one embodiment with tapered fibers. Cable 601 includes an optical fiber with two tapered fibers, a jacket, and two connectors. As shown, cable 601 includes a first end 602, a second end 604, and a middle portion 608. First end 602 includes a connector 603 and second end 604 includes a connector 605. First end 602 and second end 604 include tapered fibers and may be relatively short (e.g., 2 cm or shorter). Middle portion 608 may be relatively long (e.g., 10 km). In other embodiments, first end 602 and second end 604 may be longer (e.g., a few meters). In other embodiments, middle portion 608 may be longer or shorter (e.g., less than 600 m).

Cable 601 may provide the advantages of a single-mode fiber because a substantial portion of its length has a single-mode core. On the other hand, cable 601 may have some of the benefits of a multi-mode fiber cable because the exposed face of the fiber includes a multi-mode core. In another embodiment, one of the ends of the cable does not include a tapered fiber. In this embodiment, the face of one end of the cable may expose a single-mode core and the face of the other end of the cable may expose a multi-mode core.

FIG. 6B is a diagram illustrating a fiber optic cable 611 according to another embodiment. Cable 611 includes an optical fiber with one tapered fiber at end portion 612. End portion 612 may also be coupled to a socket 614 (which may also be considered a connector). Socket 614 may be mounted on housing 404 of splitter 400, for example. Socket 614 may mate, for example, to either connector 603 or connector 605 described above. Cable 611 may also include a jacket 616. In this embodiment, a technician who connects cable 601 to socket 614 (e.g., to housing 404) has the easier job of coupling two multi-mode cores rather than two single-mode fibers. The increased core diameter of the face of the fiber in socket 614 makes it easier to clean, polish, and align to the matching fiber at the face of connector 603 and/or connector 605.

FIG. 7A illustrates a machine to manufacture a tapered optical fiber. In this embodiment, the nearly cylindrical length of fiber pre-form 702 is heated and its ends are then pulled apart at a prescribed velocity or tension, for example. A tapered fiber may be manufactured from a pre-form 702. Pre-form 702 is a silica rod with a diameter of, for example, a few centimeters with a core of either pure or doped silica surrounded by a cladding layer of silica with a lower refractive index. An optical fiber 704 is then drawn in a drawing tower 706 by heating pre-form 702 in a furnace at the top of tower 706 and pulling fiber 704 in a controlled way to ensure the desired fiber diameter, as measured by a diameter meter 708. The drawing conditions (e.g., velocity and/or tension) may be changed under computer control so the fiber diameter may be changed in a linear manner.

In one embodiment, the resulting fiber 704 may then be coated by a coating cup 710. The tapered portion of fiber 704 may be less than a centimeter in length, a few centimeters, a few decimeters, a meter, or a few meters, for example. Other methods of forming a tapered fiber 704 may be used. For example, the pre-form may be an un-coated optical fiber with a diameter of 125 μm and a core of 50 μm.

FIGS. 7B and 7C illustrate the manufacture of a tapered fiber in another embodiment. As shown in FIG. 7B, the manufacturing process may begin with a multi-mode fiber 751 (e.g., with a diameter of 125 μm and a 50 μm core) that is held at one end by a first support 752 and at the opposite end by a second support 754. In this embodiment, support 752 is stationary and support 754 may move relative to support 752. In other embodiments, both supports 752 and 754 may move. As shown in FIG. 7C, heat 782 may be applied to fiber 751 while support 754 moves away from support 752. Fiber 751 may stretch in a controlled way so as to cause fiber 751 to have a 50 μm core at one end and a 9 μm core at the other end. A tapered portion 753 may vary (e.g., linearly) from 50 μm at one end to 9 μm at the other end of fiber 751, but other transition functions are possible.

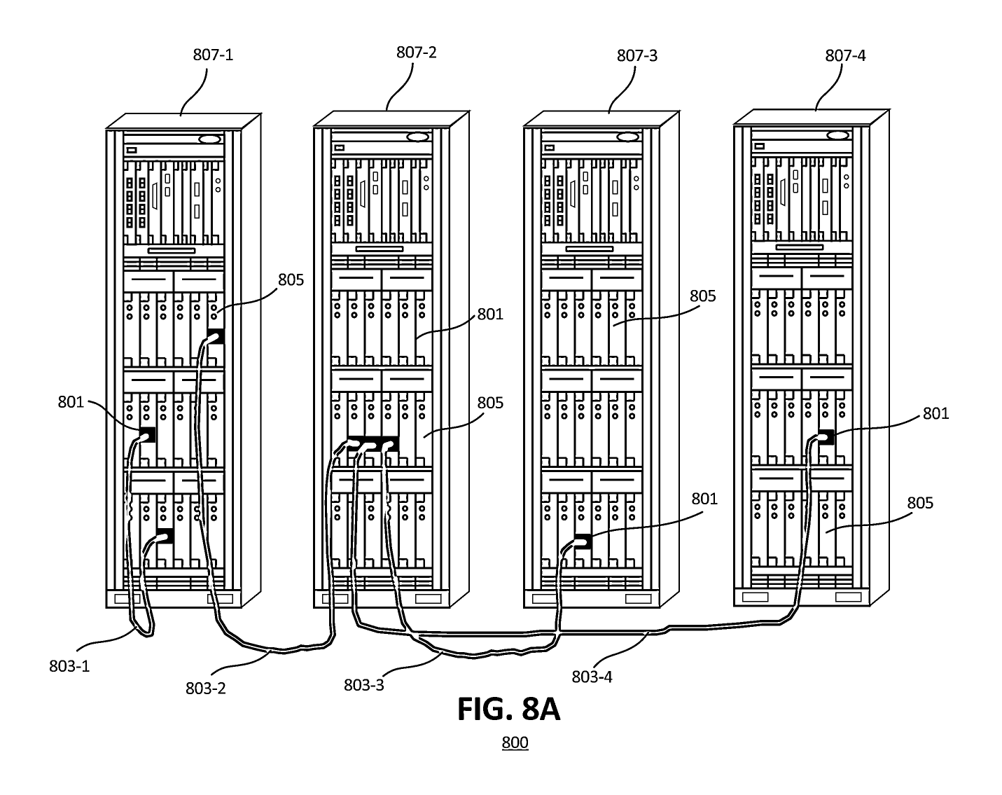

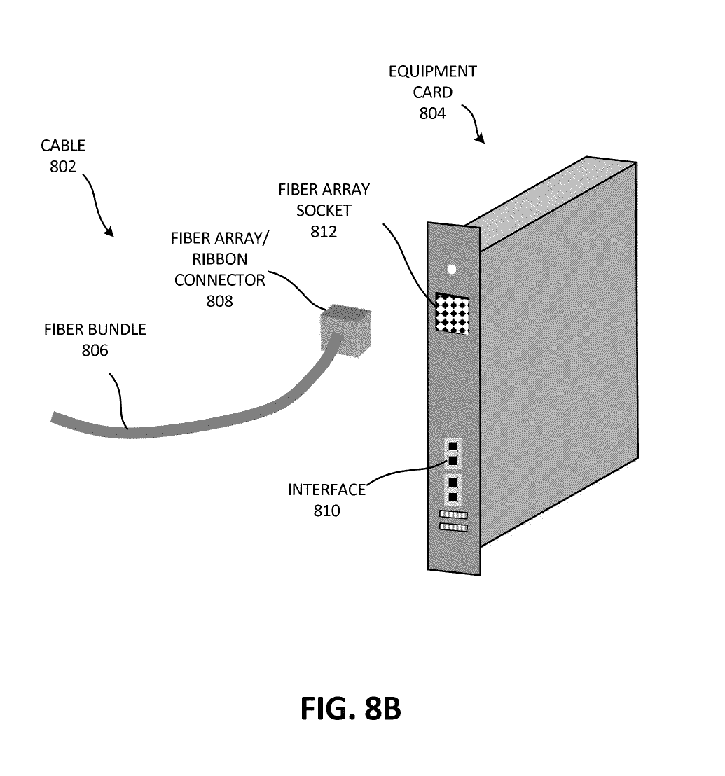

FIG. 8A is a diagram of an overview of an exemplary network 800 described herein. Network 800 may include four network devices 807-1 through 807-4 (collectively, “network devices 807”). Network devices 807 may each include a chassis for receiving equipment cards 805, such as a line card for a router, switch, or switch fabric, for example. Embodiments disclosed herein allow for an optical fiber connector (or “coupler”) 801 for connecting equipment cards 805 and/or network devices 807 with cables 803. In one or more embodiments, connector 801 and cable 803 may include many (e.g., 4, 6, 8, 12, or 24) of optical fibers. Other embodiments may include hundreds if not thousands of optical fibers. In one or more embodiments, connector 801 may include tapered fiber ends as described herein for aligning the optical fibers.

FIG. 8B is an illustration of an exemplary cable 802 and an exemplary equipment card 804. Card 804 may be a line card for a router chassis, a switch card for a switch chassis, or any other type of network equipment. Cable 802 may include a fiber bundle 806 and a fiber array (or ribbon) connector 808 at the end of fiber bundle 806. Fiber bundle 806 may include more than one optical fiber, e.g., bundle 806 may include anywhere between 2, 4, 6, 8, 12, 24, 48, 64, 128, 500, 1000, 1,500, 2,000, 3,000, 4,000, 5,000, 10,000, or more optical fibers. All or some of the optical fibers may end at (e.g., be exposed in) connector 808 for connecting to another network device, such as card 804.

Card 804 may include an interface 810 and a fiber array socket 812. Interface 810 may provide a physical interface for receiving and sending data (e.g., packets) to an external node. For example, interface 810 may include a fiber optic port for receiving a fiber optic cable, such as the port described with respect to FIG. 6B. Fiber-array socket 812 may receive fiber array connector 808. Socket 812 may also include fiber optic cables in the same number, in one embodiment, as the number of fiber optic cables in fiber bundle 806. Fiber-array socket 812 may, in one embodiment, include multi-mode fiber diameter that tapers into a single-mode fiber, as described above. In this embodiment, optical communications from the fibers in cable 802 may pass to the fibers in socket 812 and into card 804. That is, the fibers exposed in connector 808 and socket 812 may appear as in FIG. 5B. In one embodiment, fiber bundle 806 includes 4, 6, 8, 12, or 24 optical fibers (e.g., a 1×4, 1×6, 1×8, 1×12 or 1×24 array, respectively) and socket 812 includes 4, 6, 8, 12, or 24 fibers, respectively, for communications. In another embodiment, fiber bundle 806 includes 3,136 (e.g., 56×56) optical fibers and socket 812 also includes 3,136 optical fibers for receiving communications from each of the fibers in bundle 806.

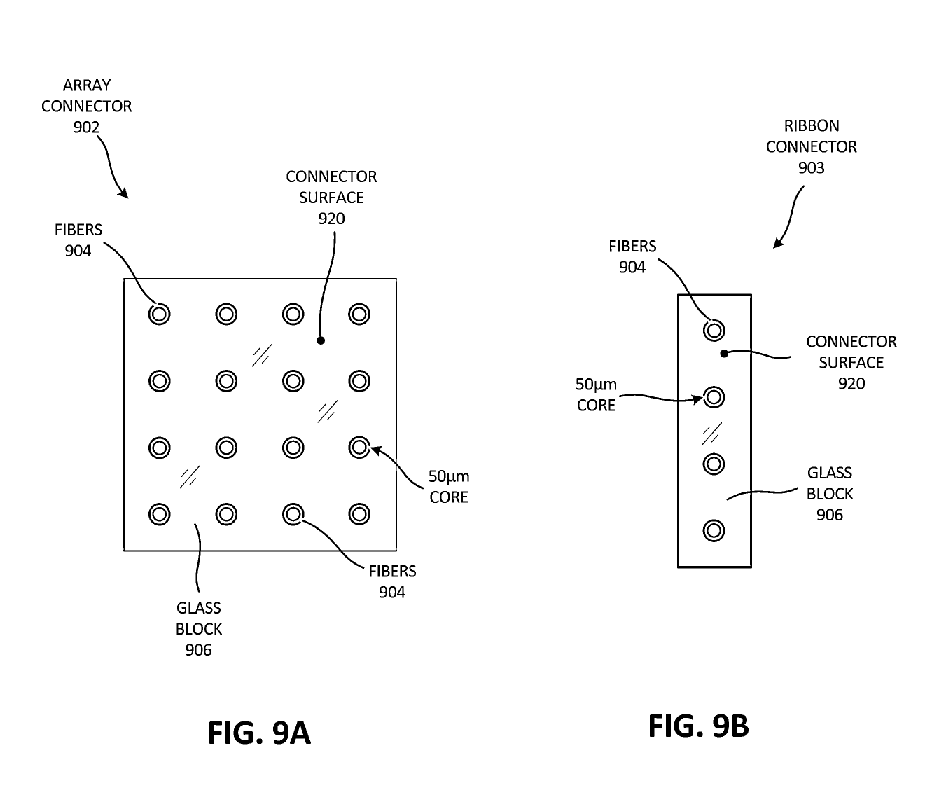

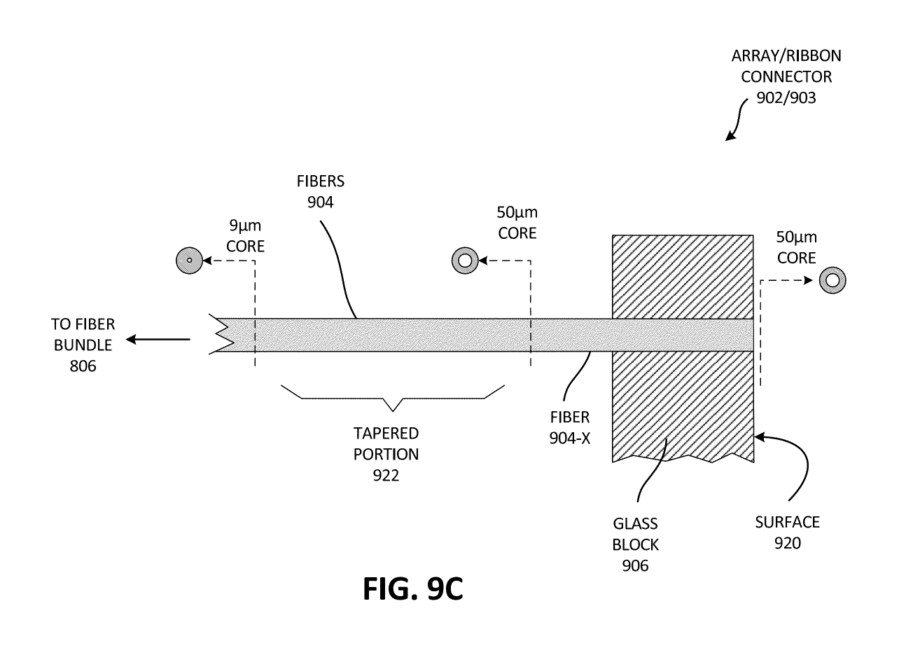

FIGS. 9A and 9B are illustrations of an exemplary fiber array/ribbon connectors. FIG. 9A is a view of a connector 902 from the end. Connector 902 may include fibers 904, and a glass block 906. Fibers 904 (individually fiber 904-x) may form an array, such as a square array shown in FIG. 9A. Glass block 906 may retain fibers 904, e.g., fibers 904 may be mounted in and pass through glass block 906. In the embodiment of FIG. 9A, connector 902 includes 16 fibers. As discussed above with respect to connector 808, fewer or many more fibers are possible. For example, connector 902 may include 3,136 optical fibers (e.g., a 56×56 array). As shown in FIG. 9A, the face of each fiber 904 may include a 50 μm (or a multi-mode) core.

FIG. 9B is a view of a connector 903 from the end. Connector 903 is similar to connector 902, but is an array with only one column (or row). Connector 903 may also include fibers 904 and a glass block 906. Fibers 904 may form a single-column or single-row array, such as a rectangular array shown in FIG. 9B. Glass block 906 may retain fibers 904, e.g., fibers 904 may be mounted in and pass through glass block 906. In the embodiment of FIG. 9B, connector 903 includes 4 fibers. As discussed above with respect to connector 808, fewer or many more fibers are possible. For example, connector 903 may include 6, 8, 16, or 24 or more optical fibers in a single-row or single-column array. As shown in FIG. 9B, the face of each fiber 904 may include a 50 μm (or a multi-mode) core.

FIG. 9C shows a cross section of a portion of connector 902 or connector 903. As shown in FIG. 9C, the end of fiber 904-x may be substantially in the same plane as a surface 920 of glass block 906. The configuration of this embodiment may allow for easy cleaning of the end surface of fibers 904 of connector 902. Clean end surface of fiber 904 may reduce degradation of optical signals passing through fiber 904. Fiber 904 in FIG. 9C also includes a tapered portion 922. Tapered portion 922 includes a core diameter that transitions from 50 μm to 9 μm. Fiber 904 may then be core-aligned and fusion spliced onto a single-mode fiber for a long haul, for example. In this embodiment, alignment and cleaning of array/ribbon connector 902/903 may be simplified (as compared to an array face that includes cores with diameters of 9 μm).

Although glass is used to position fibers 904 relative to each other in FIGS. 9A, 9B, and 9C, other materials may be used, such as plastic, metal, etc.

Thus, the tapered fiber segments allows for easier alignment of the fibers in an array, particularly where placement errors of the fibers may cumulate across the array. The taper in a fiber allows for the power in the single-mode fiber to be distributed to a larger area (e.g., from a 9 μm core to a 50 μm core). In this case, any dirt or misalignment does not block as much power as it would with a smaller core. Therefore, alignment of a large number of fibers becomes more feasible. Because of the short length of the taper, however, the mode coupling stays relatively low.

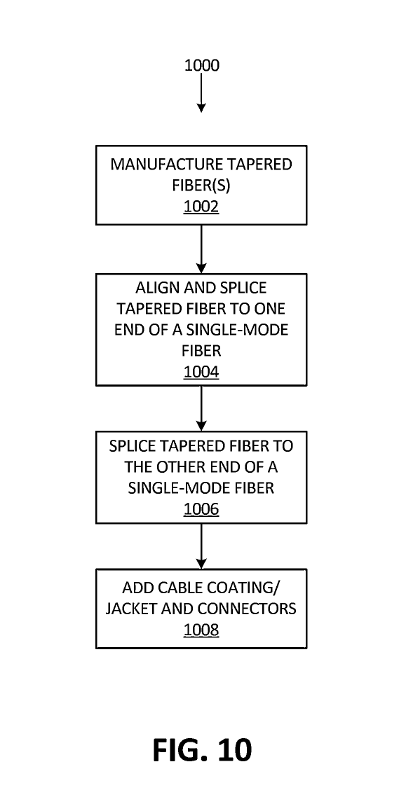

FIG. 10 is a flowchart of a process 1000 for the manufacture of cables in embodiments described herein. Process 1000 may begin with the manufacture of a tapered fiber(s) (block 1002). The manufacture of tapered fibers is described above, particularly with respect to FIGS. 7A, 7B, and 7C. The manufacture of a tapered fiber may include heating a fiber and then stretching the fiber. As described above, the tapered fiber may have a single-mode face (e.g., 9 μm) on one end and a multi-mode face (e.g., 50 μm) on the other end. A tapered fiber may then be core-aligned and fusion spliced on one end of a single-mode fiber (block 1004). That is, the end of the tapered fiber with the single-mode face (e.g., 9 μm) may be core-aligned and fusion spliced to one end of the single-mode fiber. Depending on the application, in one embodiment, a tapered fiber may also be core-aligned and fusion spliced to the second, other end of the single-mode fiber (block 1006). For example, if manufacturing a cable to be fixed between two devices (e.g., between hub 206 and ONT 214), then both ends of the single-mode fiber may include tapered fibers.

Process 1000 may continue with the attachment of connectors and the application of jackets to the fibers (block 1008). In this case, the manufactured fiber optic cable may appear as shown in FIGS. 6A and 6B. If a ribbon or an array, the fiber optic cable may appear as shown in FIG. 8B, 9A, or 9B, for example.

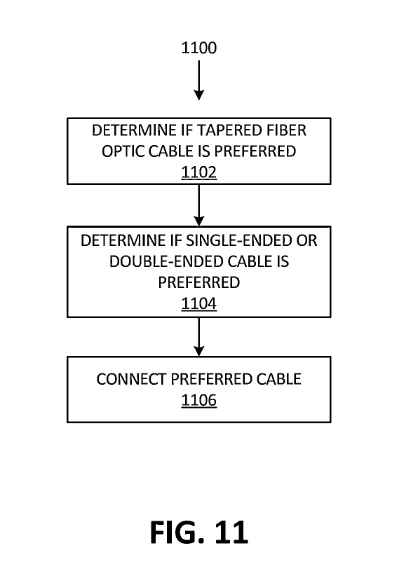

FIG. 11 is a flowchart of a process 1100 for using fiber optic cables according to the embodiments described herein. Process 1100 may begin with the technician determining whether a tapered fiber optic cable is preferred (block 1102). For example, in one embodiment, a socket (such as socket 410) may include an indication that the appropriate connector should include a tapered fiber for connection. Socket 410 may include this with color markings, for example. Process 1100 may continue with a determination if a tapered fiber optic cable is preferred on both ends, or just one end (block 1104). For example, ONT 214 may also include an indicator that the appropriate connector should include a tapered fiber for connection. For example, in one embodiment, a socket (such as a socket in ONT 214) may include an indication that the appropriate connector should include a tapered fiber for connection. ONT 214 may include this with color markings for example. Thus, according to process 1100, the operator may choose the correct type of cable (e.g., one with a tapered fiber on both ends).

While a series of blocks have been described with regard to the process illustrated in the flowcharts, the order of the blocks may be modified in other implementations. In addition, non-dependent blocks may represent blocks that can be performed in parallel. Although tapered fiber segments described above taper from a multi-mode core to a single-mode core, embodiments contemplate a transition from any first diameter core to any second diameter core, where the first diameter is greater than the second diameter.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, block, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

1. An apparatus comprising:
a first fiber segment having a core that transitions from a first core diameter at a first end to a second core diameter at a second end, wherein the first core diameter is smaller than the second core diameter, and wherein the second end is attached to a connector; and
a second fiber segment having a core with the first diameter, wherein the first end of the first fiber segment is spliced onto the second fiber segment.

2. The apparatus of claim 1, wherein the first end of the first fiber segment is fusion spliced to the second fiber segment.

3. The apparatus of claim 2, wherein the first fiber segment is less than 10 centimeters in length.

4. The apparatus of claim 3, wherein the first core diameter is less than 12 μm and the second core diameter is less than 65 μm and greater than 50 μm.

5. The apparatus of claim 3, wherein the first core diameter is a single-mode fiber core diameter and the second core diameter is a multi-mode fiber core diameter.

6. The apparatus of claim 1, wherein the transition is a linear transition.

7. The apparatus of claim 1, further comprising:
a third fiber segment having a core that transitions from the first diameter at a third end to the second diameter at a fourth end, wherein the fourth end is attached to a connector,
wherein the second fiber segment includes a fifth end and a sixth end, and
wherein the first end of the first fiber segment is spliced onto the fifth end of the second fiber segment, and
wherein the third end of the third fiber segment is spliced onto the sixth end of the second fiber segment.

8. The apparatus of claim 1, wherein the connector includes a ribbon or an array connector.

9. A method comprising:
tapering a first fiber segment to create a core that transitions from a first core diameter at a first end to a second core diameter at a second end, wherein the first core diameter is smaller than the second core diameter;
splicing a second fiber segment having a core with the first diameter to the first end of the first fiber segment; and
attaching a connector to the second end of the first fiber segment.

10. The method of claim 9, wherein splicing includes fusion splicing.

11. The method of claim 10, wherein the first fiber segment is less than 10 centimeters.

12. The method of claim 9, wherein the transition is a linear transition.

13. The method of claim 9, further comprising:
tapering a third fiber segment to create a core that transitions from the first diameter at a third end to a second diameter core at a fourth end; and
attaching the fourth end to a connector;
wherein the second fiber segment includes a fifth end and a sixth end, and
wherein splicing includes splicing the first end of the first fiber segment onto the fifth end of the second fiber segment, the method further comprising splicing the third end of the third fiber segment onto the sixth end of the second fiber segment.

14. The method of claim 9, wherein attaching the connector to the second end of the first optical fiber segment includes attaching a ribbon connector or an array connector to the second end of the first optical fiber segment.

15. The method of claim 9, further comprising:
connecting the connector to a socket, wherein the socket holds a fiber segment that includes a core that transitions from the first core diameter to the second core diameter, and wherein the core having the second core diameter is exposed.

16. An apparatus comprising:
a first fiber segment having a core that transitions from a single-mode core at a first end to a multi-mode core at a second end, wherein the second end is attached to a connector; and
a second fiber segment having a single-mode core, wherein the first end of the first fiber segment is core-aligned and fusion spliced to the second fiber segment.

17. The apparatus of claim 16, wherein the first end of the first fiber segment is fusion spliced to the second fiber segment.

18. The apparatus of claim 17, wherein the first fiber segment is less than 10 centimeters.

19. The apparatus of claim 16, wherein the transition is a linear transition.

20. The apparatus of claim 16, further comprising:
a third fiber segment having a core that transitions from a single-mode core at a third end to a multi-mode core at a fourth end, wherein the fourth end is attached to a connector,
wherein the second fiber segment includes a fifth end and a sixth end, and
wherein the first end of the first fiber segment is spliced onto the fifth end of the second fiber segment, and
wherein the third end of the third fiber segment is spliced onto the sixth end of the second fiber segment.

21. The apparatus of claim 16, wherein the connector includes a ribbon connector or an array connector.
